(19) United States
(12) Patent Application Publication
(10) Pub. No.: US 2009/0095413 A1
(43) Pub. Date: Apr. 16, 2009

(54) COMPOSITE REINFORCEMENT OF METALLIC STRUCTURAL ELEMENTS

(75) Inventors: Willard N. Westre, Bellevue, WA (US); Leanna M. Micona, Seattle, WA (US); Mark S. Wilenski, Seattle, WA (US); Gary R. Weber, Kent, WA (US)

Correspondence Address: BAKER & HOSTETLER, LLP;FOR BOEING COMPANY, WASHINGTON SQUARE, SUITE 1100, 1050 CONNECTICUT AVENUE, N.W., WASHINGTON, DC, 20036, US

(73) Assignee: The Boeing Company, Chicago, IL (US)

(21) Appl. No.: 12/338,293

(22) Filed: Dec. 18, 2008

Related U.S. Application Data
(62) Division of application No. 11/154,522, filed on Jun. 17, 2005.

(51) Int. Cl. B32B 37/00

(52) U.S. Cl. 156/257; 156/275.5

(57) ABSTRACT

A selectively reinforced hybrid metal-composite structural element can include a metal element and a composite material. The composite material can be bonded to the metal element by an adhesive layer including a polymer matrix using a radiation curing process, resulting in insubstantial or negligible residual stresses at the bond line between the metal element and the composite element. The structural element also can include a metal closeout cap to provide a barrier from a corrosive atmosphere, and the adhesive layer can encapsulate the composite element to provide a corrosion-resistant barrier between the composite element and the surrounding metal.

### CROSS-REFERENCE TO RELATED APPLICATIONS

This application claims priority to and is a divisional application of U.S. patent application entitled, COMPOSITE REINFORCEMENT OF METALLIC STRUCTURAL ELEMENTS, filed Jun. 17, 2005, having a Ser. No. 11/154,522, the disclosure of which is hereby incorporated by reference in its entirety.

### FIELD OF THE INVENTION

The present disclosure relates generally to structural reinforcement. More particularly, the present invention relates to selective reinforcement of metallic structural elements using composite materials.

### BACKGROUND OF THE INVENTION

Structural elements are used to maintain the structural integrity of a wide variety of structures, including, for example, bridges, buildings, airplanes, trains, sea vessels and propellers. A structural element for a particular application generally can be either selected from existing types of commonly available structural elements or specially designed to suit the needs of an application.

In either case, the cross-sectional shape of the structural element often is selected or designed to include more material at locations in the cross-section that will experience greater stress under the design loading. Thus, structural elements can be designed to carry specific types of loads. For example, common structural elements designed to be especially robust under bending loads include I-beams, L-shaped beams, C-shaped channels, and the like.

In addition, structural elements can be made from many different materials, including metals, metal alloys, composite materials, and the like. Generally, a material for a particular structural element is selected because of specific material properties that meet the requirements of a particular application. For example, a metal may be chosen for a particular structural element designed to endure multiple types of loading in various directions, because of the isotropic properties of metals. As another example, if weight is of concern in the design of a structural element, a composite material may be chosen because of the specific strength or the specific modulus of elasticity—that is, the tensile strength to specific gravity ratio, or the modulus of elasticity to specific gravity ratio—of composites. Weight savings can be particularly advantageous in certain applications; for example, in aircraft applications weight improvements can increase fuel efficiency, which reduces the cost of operation and increases the range of the aircraft. Thus, for a particular application, a specific cross section and material combination can be selected for a structural element in order to produce certain characteristics.

Nevertheless, in some applications the properties of more than one type of material may be desirable. For example, a combination of a metal structure and a composite structure may be desirable in an application designed for multiple or complex loadings where the primary loading type is known and the weight of the structural element is a concern. However, when composite materials have been bonded to metal elements using conventional thermal composite matrix curing techniques, in at least some instances the differential thermal contraction between the metal element and the composite material following the relatively high-temperature curing has resulted in significant residual stresses at the bond interface between the metal element and the composite material, weakening the structure and essentially defeating the purpose of bonding the two materials.

Accordingly, it is desirable to provide a method and apparatus that combines a composite material with a metal element to form a hybrid structural element that can at least to some extent provide acceptable residual stresses at the bond interface between the composite material and the metal element.

### SUMMARY OF THE INVENTION

The foregoing needs are met, to a great extent, by the present invention, wherein in one aspect an apparatus is provided that in some embodiments bonds a composite material to a metal element using a radiation curing process in order to form a hybrid structural element.

In accordance with one aspect of the present invention, a reinforced hybrid structural element can include a metal element and a composite ply. In addition, the composite play can be bonded to the metal element using radiation. The structural element can optionally include an adhesive layer that is at least partially cured using radiation in order to bond the composite ply to the metal element.

In accordance with another aspect of the present invention, a method of manufacturing a selectively reinforced hybrid structural element can include the steps of providing a metal element and laying up a composite ply over at least a partial surface of the metal element. In addition, the method can include at least partially curing a polymer matrix using radiation in order to bond the composite ply to the metal element. The method can optionally include the step of placing an adhesive layer that includes the polymer matrix over at least the partial surface of the metal element; in this case, the step of laying up also can include laying up the composite ply over the adhesive layer.

In accordance with yet another aspect of the present invention, a reinforced hybrid structural element can include a metal element and a composite ply. Furthermore, the structural element can include means for bonding the composite ply to the metal element at least partially cured using radiation.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cross-sectional view illustrating a hybrid metal-composite I-beam according to a preferred embodiment of the invention.

FIG. 2 is a cutaway perspective view of the hybrid metal-composite I-beam of FIG. 1.

FIG. 3 is a cross-sectional view illustrating a hybrid metal-composite track member for supporting and constraining airplane seats.

FIG. 4 is a flow chart illustrating steps that may be followed in accordance with one embodiment of the method or process.

FIG. 5 is a representative radiation curing system.

### DETAILED DESCRIPTION

Some embodiments in accordance with the present invention provide a hybrid metal-composite structural element that includes a metal element and a composite material bonded together using radiation curing. The structural element can include an adhesive layer between the metal element and the composite material to bond the composite material to the metal element and to act as a corrosion-resistant barrier between the metal and the composite element.

Composite materials including a polymer matrix are generally fabricated by one of three types of processes. The first type is a chemical curing process in which a two-part epoxy matrix is combined and a spontaneous chemical reaction occurs between the components of the two parts, resulting in cross-linking between the polymer molecules. The second type is a thermal curing process used with thermosetting or thermoplastic matrices in which an elevated temperature causes cross-linking or consolidation of the polymer molecules. The third type is a radiation curing process, in which radiation—typically in the form of ultraviolet rays, X-rays or an electron beam—is applied to a polymer matrix to induce a cross-linking reaction between the polymer molecules.

As used here, radiation can include electromagnetic radiation or a charged particle beam. For example, radiation can include gamma rays, ultraviolet rays or X-rays in a wavelength range from approximately 10 femtometers (fm) to approximately 380 nanometers (nm). In addition, for example, radiation can include an electron beam or a cation beam with an energy level up to 10 megaelectron volts (MeV).

When a composite material is bonded to a metal by way of a thermal curing process, bonding between the composite material and a metal takes place at a relatively high temperature—typically between 250 and 350 degrees Fahrenheit. Because the coefficients of thermal expansion of metals compared to those of typical composite materials are relatively high, as the structural element cools down after the curing cycle a significant differential thermal contraction occurs between the metal and the composite material—that is, the metal contracts significantly more than the composite material contracts. Thus, residual stresses develop at the bond interface between the metal and the composite material. As a result, for example, reinforcement of aluminum structural elements with thermally-cured composites has not previously been efficient or feasible, because of the differential thermal expansion between the aluminum and the composite material.

In contrast, radiation curing of composite materials can result in relatively small temperature increases in the composite material—for example, the temperature increase can be as low as or lower than five degrees Fahrenheit. Two categories of radiation curing have become known in the art. The first category includes free radical polymerization, in which a matrix including, for example, acrylate monomers can be exposed to radiation, resulting in cross-linking between the acrylate monomers. The second category includes cationic polymerization, wherein special photoinitiators such as, for example, iodonium salts, can be included in the matrix in order to generate cations or protons when radiation is applied. The cations or protons can act as an initiator to cause a cross-linking reaction.

Since radiation curing processes result in such a small temperature increase, a composite material can be bonded to a metal structural element without significant differential thermal contraction. As a result, radiation curing enables the use of composite materials containing high strength resins to reinforce metal structural elements. Selective reinforcement of a metallic structural element with a composite material can increase the strength as well as the stiffness of the structural element.

Because of the minimal temperature increase during the radiation curing cycle, the residual stresses at the bond interface between the metal element and the composite material is negligible or insubstantial. Thus, a high-specific-strength and high-specific-modulus-of-elasticity structural element is produced having properties of both a metallic structural element and a composite structural element. The invention will now be further described with reference to the drawing figures, in which like reference numerals refer to like parts throughout.

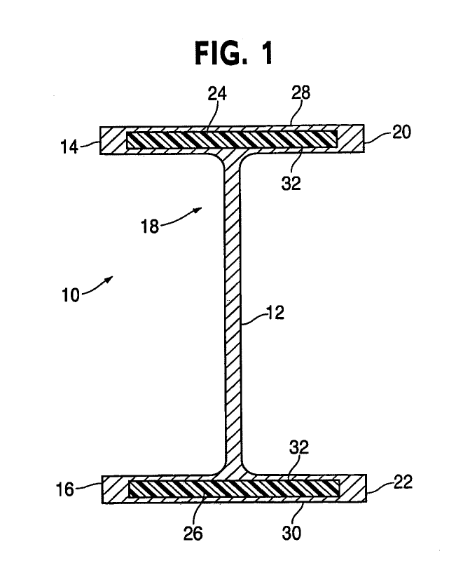

An embodiment of the present invention can include a structural element such as the I-beam 10 shown in FIG. 1. The I-beam 10 can include a web member 12, an upper cap member 14, and a lower cap member 16. (The terms “upper” and “lower” are used here solely for the purpose of distinguishing the two cap members from each other. These terms do not imply a specific orientation of the structural element in a particular application.)

The I-beam 10, or other structural element, can include a metal element 18, containing a metal, such as aluminum, copper, silver, magnesium, titanium, tungsten, iron, nickel, etc.; or a metal alloy, such as an aluminum alloy, titanium alloy, brass, bronze, steel, etc. The metal element can include, for example, the web member 12 and portions 20, 22 of the cap members 14, 16. The I-beam 10 also can include a reinforcing composite ply 24 located in the upper cap member 14, a reinforcing composite ply 26 in the lower cap member 16, a metal closeout cap 28 on the upper cap member 14, and a metal closeout cap 30 on the lower cap member 16. The composite plies 24, 26 can be located in the cap members 14, 16 approximately where the compressive and tensile stresses in a beam under a bending load are highest. In general, a composite material can be located at a selected, relatively high-stress location of a metallic structural member cross section in order to provide selective reinforcement of the structural member.

The composite plies 24, 26 can be cured by a radiation process, for example, an electron-beam curing process. Although a preferred embodiment includes an electron-beam curing process, other embodiments can include an ultraviolet radiation, X-ray, or other radiation curing process. The minimal temperature rise during the radiation curing cycle results in negligible or insubstantial residual stresses at bond interfaces 32 between the metal portion 20 of the upper cap member 14 and the composite ply 24, and between the metal portion 22 of the lower cap member 16 and the composite ply 26. As a result, this configuration combines the properties of the metal element 18 and the high specific strength and specific modulus of elasticity, or stiffness, of the composite plies 24, 26.

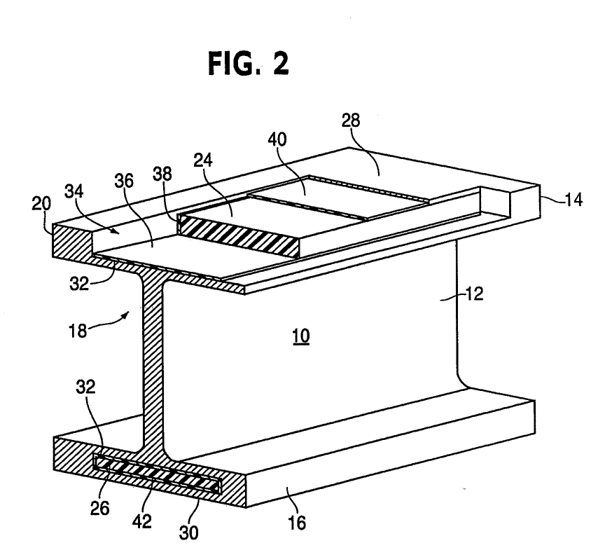

FIG. 2 shows a cutaway perspective view of the I-beam 10 in FIG. 1. As shown in FIG. 2, the I-beam 10 can have a portion of the metal element 18 removed to create a space 34 where the composite ply 24 can be placed. For example, a space 34 can be machined out of a metal element 18 by way of milling, drilling, or the like. In FIG. 2, the space 34 has been machined out of the metal portion 20 of the upper cap member 14. In other embodiments, the composite ply can be placed on the external surface of the metal element, or the space can be created during the fabrication of the metal element, for example, using a forging or die process.

In addition, in some embodiments an adhesive layer 36 can be placed over the surface of the metal element 18 that interfaces with the composite ply 24. The adhesive layer 36 can include a polymer matrix such as, for example, an epoxy. In an alternative embodiment, the adhesive layer 36 can be formed from a resin that forms the matrix phase of the composite ply 24. Furthermore, a side adhesive layer 38 can be included if the metal portion 20 of the cap member 14 extends upward along the side of the composite ply 24.

Then, the composite ply 24 can be laid up over the adhesive layer 36 in order to reinforce the I-beam 10. The composite ply 24 can include a matrix phase reinforced by fibers, such as carbon, graphite, boron, silicon carbide, silicon nitride, aluminum oxide, magnesium oxide, fused silica, zylon, aramids, nylon, asbestos, or the like. The matrix phase can include a thermosetting polymer such as, for example, an epoxy, bismaleimide (BMI), polyimide, cyanate ester, polyester, silicon, or phenolic resin.

In some embodiments, the I-beam 10 can also include an upper adhesive layer 40 and a metal closeout cap 28, which can protect the composite ply 24 from a corrosive environment. In addition, the metal closeout cap 28 can provide an impact-resistant surface to protect the composite ply 24 from impact damage.

Some metals, such as aluminum, for example, can be highly corrosive when in contact with a composite material, such as carbon or graphite fiber. Thus, in order to extend the life of the composite ply 24, the adhesive layer 36, 38, 40 can provide a corrosion-resistant barrier between the composite ply 24 and the metal element 18 to protect the composite ply 24 from the corrosive effects of the metal. Thus, as shown in the lower cap member 16 of FIG. 2, the composite ply 26 can be fully enclosed, or encapsulated, by an adhesive layer 42 that envelopes the composite ply 26.

In addition, the adhesive layer 36, 38, 40, 42 can include glass fiber reinforcement, for example soda-lime glass, Pyrex® glass, E-glass, S-glass or astroquartz fibers. The addition of glass fiber reinforcement to the adhesive layer 36 can be especially beneficial toward providing a corrosion-resistant barrier between the metal element 18 and the composite ply 24, 26, because when coupled with the various polymer matrices, the glass fiber can provide physical isolation which can reduce or eliminate the possibility of galvanic corrosion between the composite and metal.

In addition, the thickness provided by glass fiber reinforcement in the adhesive layer 36, 38, 40, 42 can provide an additional physical barrier between the metal element 18 and the composite ply 24, 26. For example, as little as five grams per square meter of randomly-oriented glass fibers in an epoxy matrix can provide a robust corrosion-resistant barrier. This barrier can be very thin—for example ten thousandths of an inch or less, or even vanishingly thin—and still provide substantial corrosion resistance.

The adhesive layer 36, 38, 40, 42, as well as the composite ply 24, 26, can be cured by a radiation process, for example, an electron-beam curing process. Once again, although a preferred embodiment includes an electron-beam curing process, other embodiments can include an ultraviolet radiation, X-ray, or other radiation curing process. Once again, the minimal temperature rise during the radiation curing cycle results in negligible or insubstantial residual stresses at bond interfaces 32 between the metal portion 20 of the upper cap member 14 and the adhesive layer 36, 38, 40, and between the metal portion 22 of the lower cap member 16 and the adhesive layer 42. As a result, this configuration also combines the isotropic properties of the metal element 18 and the high specific strength and specific modulus of elasticity of the composite plies 24, 26.

The reinforcing fibers in the composite ply 24, 26 can be generally aligned in a general fiber orientation, which can be aligned with the stresses caused by the loading type for which the structural element is designed. For example, in one embodiment the fibers in the composite ply 24, 26 can be axially aligned in parallel with a longitudinal centerline of the I-beam 10. In an alternative embodiment, the fibers can be axially aligned normal to the longitudinal centerline of the I-beam 10. Similarly, in another embodiment the fibers can be oriented at approximately forty-five degrees from the longitudinal centerline in order to provide strength in shear loading.

Furthermore, in order to impede crack propagation through the composite ply 24, 26 the reinforcing fibers can be axially aligned at relatively small angles on both sides of the longitudinal centerline of the I-beam 10. For example, in yet another embodiment the fibers can be oriented at approximately five degrees from each side the longitudinal center line. Moreover, in various embodiments multiple composite plies 24, 26 can include fiber orientations aligned at different angles in order to provide strength for complex or multiaxial loadings.

The composite ply 24, 26 can include a composite fabric, or a composite tape. In addition, the composite ply 24, 26, optionally including a composite tape or composite fabric, can be pre-impregnated with a resin before being laid up on the metal element 18. Furthermore, the composite ply 24, 26 can be precured, that is, the composite ply 24, 26 can be partially or fully cured before being laid up on the metal element 18, and the adhesive layer 36, 38,40,42 can be cured using radiation to bond the precured composite ply 24, 26 to the metal element 18.

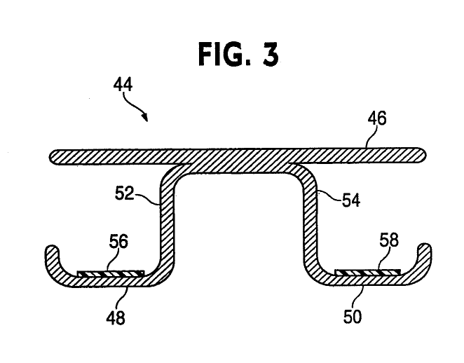

An alternative embodiment of a structural element selectively reinforced with a composite ply is shown in FIG. 3. This embodiment is an example of an application-specific selectively reinforced hybrid metal-composite structural element. The structural element shown in FIG. 3 is a seat track 44 designed to support and constrain airplane passenger seats. The seat track 44 includes a track member 46 which is connected to two channels 48, 50 by two support members 52, 54. The track member 46, the channel members 48, 50 and the support members 52, 54 are made of a metal, for example, titanium.

In addition the seat track 44 includes reinforcement elements 56, 58 along each of the channels 48, 50. In this embodiment, metal is not removed from the metal element to create a space for the composite plies. Instead, the composite plies are bonded to the exterior surface of the metal element. The reinforcement elements 56, 58 are bonded to the metal channels 48, 50 by way of a radiation curing process, optionally including an adhesive layer between the reinforcement elements 56, 58 and the metal channels 48, 50. The reinforcement elements 56, 58 provide substantial strength to prevent compression crippling of the seat track channels 48, 50 by limiting the deflection of the channels 48, 50. This configuration can provide a relatively lightweight, high-strength seat track 44.

Additional alternative embodiments of the present invention can include structural members of virtually any shape or form. For example, a sine wave beam, which includes a sine wave-shaped web member and cap members similar to an I-beam, can include selective reinforcement along the lower or upper cap member by a composite material to increase the beam's resistance to deflection.

In addition, alternative embodiments can include a reinforcement element that is a hybrid laminate of alternating layers of a metal foil and a fiber-reinforced composite material. For example, the reinforcement element can include a titanium-polymer hybrid laminate, such as that disclosed in U.S. Pat. No. 6,114,050, entitled TITANIUM-POLYMER HYBRID LAMINATES, to Westre, et al., issued Sep. 5, 2000, the disclosure of which is hereby incorporated by reference in its entirety.

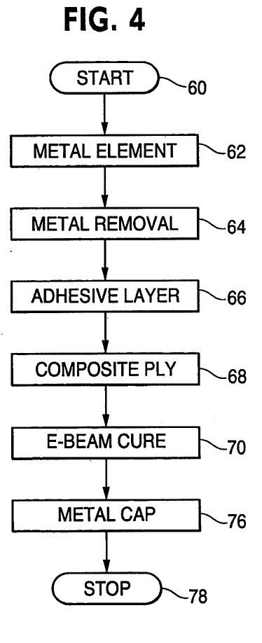

An embodiment of the present invention can further include a process or method for manufacturing a selectively-reinforced hybrid metal-composite structural element. A flow chart illustrating steps that can be included in an embodiment are shown in FIG. 4. The process starts in step 60 and in step 62 a metal element can be provided. As discussed above, the metal element serves as the core of the structural element, and can be formed or machined to provide any suitable cross-section, in accordance with the loading types the structural element is designed to carry. The metal element can be produced using any suitable means, such as stamping, forming or machining. However, fabrication of the metal element is optional, and the metal element can be optionally procured from another source.

In step 64, a portion of the metal can be removed from the metal element in order to provide a space where the composite reinforcement element can be located. The metal can be removed by any suitable means, including a machining process, such as milling or drilling, a mechanical process, a heat process, an electrochemical process, or the like. Typically, the metal is removed from an area of the structural member cross-section that will carry a relatively high stress when the structural element is under an anticipated type of loading.

In step 66 an adhesive layer can be placed over a surface of the metal element 18 where a composite ply is to be located. As discussed above, the adhesive layer can include glass fiber reinforcement, for example soda-lime glass, Pyrex® glass, E-glass, S-glass or astroquartz fibers. The adhesive layer can form a simple planar layer over a surface of the metal element, or the adhesive layer can also include a side or sides. As further discussed above, the adhesive layer can also include an upper layer in order to provide a corrosion-resistant layer around the composite ply, effectively encapsulating the composite ply in order to isolate the composite ply from the environment.

Next, a composite ply is laid up on the metal element in step 68. As discussed above, the composite ply can include a resin and a fiber reinforcement, such as graphite or aramid fibers. Alternatively, step 68 can include laying up multiple composite plies, one over another. In addition, the reinforcement fibers of a composite ply can be oriented in a direction of a loading type which the structural element is designed to carry. For example, the fiber orientation can be aligned parallel to a longitudinal centerline of the structural element, at approximately forty-five degrees from the longitudinal centerline, normal to the centerline, or at five degrees from each side of the center line.

In embodiments that include multiple composite plies, the individual plies can include fiber orientations in differing directions. For example, an embodiment can include a zero-degree ply, wherein the fiber orientation is approximately parallel to the longitudinal centerline of the structural element; a ninety-degree ply, wherein the fiber orientation is approximately normal to the longitudinally centerline; a forty-five-degree ply, wherein the fiber orientation is approximately forty-five degrees from the centerline; and a five-degree ply, wherein the fiber orientation is approximately five degrees from the centerline of the structural element; or any combination of these or other fiber-orientation plies.

In step 70, the adhesive layer and the composite ply can be cured using a radiation process, for example, an electron-beam curing process. Nevertheless, as explained above, even though a preferred embodiment includes an electron-beam curing process, other embodiments can include an ultraviolet radiation, X-ray, or other radiation curing process. Alternatively, the composite ply can be pre-cured, and the adhesive layer can be cured using radiation.

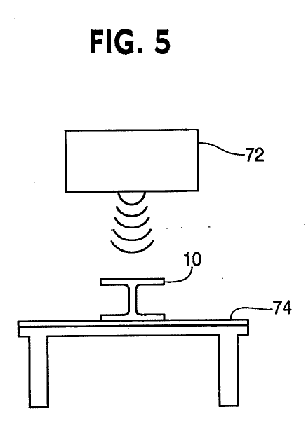

As an example, a representative radiation curing system is shown in FIG. 5, including a radiation generator 72 and a manufacturing tool 74 configured to hold the structural element 10. For example, the radiation generator 72 can include an ultraviolet radiation source, an X-ray machine, or an electron beam generator, or “electron gun.” Examples of electron beam generators suitable for use with some embodiments of the invention include the Rhodotron series of compact, high power electron beam accelerator systems, such as the TT 100, TT 200, TT 300 and TT 1000 models, which operate at outputs of 3-10 MeV in a power range from 35 kW to 700 kW, manufactured by IBA Technology Group of Louvain-la-Nueve, Belgium.

Furthermore, in some configurations, the radiation generator 72 can be configured to move over the areas to be cured on the structural element 10, which can be held stationary by the manufacturing tool 74. In other configurations, the structural element 10 can be moved under a stationary radiation generator 72 by the manufacturing tool 74.

As discussed above, in some embodiments the radiation curing cycle can result in a minimal increase in the temperature of the composite ply, for example, as low as five degrees Fahrenheit or less, resulting in a negligible or insubstantial residual stress at the bond interface between the metal element and the composite ply or adhesive layer. Nevertheless, in other embodiments, the radiation curing can occur at a higher temperature that is below the temperature range of conventional thermal curing, for example, below approximately 120 degrees Celsius (approximately 248 degrees Fahrenheit). Alternatively, the temperature of the metal element and the composite ply or adhesive layer during the radiation curing cycle can be maintained within an acceptable range—for example, within 75 degrees Celsius (approximately 135 degrees Fahrenheit)—of the intended design application temperature, that is, the temperature at which the structural element is designed to be used.

In an alternative embodiment, the adhesive layer cure can be initiated with a radiation process, initially forming a relatively weak bond between the metal element and the composite ply, and the curing process can be completed by a thermal process at an elevated temperature without inducing thermal distortion, since the initial bonding between the metal and the composite ply has occurred during the radiation curing. Similarly, in other embodiments, the adhesive layer and the composite ply both can be initially cured by a radiation process, and the curing process can be later completed by a thermal process. Furthermore, in various embodiments the composite ply, the adhesive layer and the metal element can be actively cooled during the curing process, for example, with a fan, water, or the like.

Then, in step 76, a metal closeout cap can be optionally overlaid upon the composite ply. As discussed above, the metal closeout cap can provide an impact-resistant shell, as well as provide a barrier to protect the composite ply from a corrosive environment. In this case, the composite ply can be fully enveloped, or encapsulated, by the adhesive layer in order to provide a corrosion-resistant barrier between the composite ply and the metal element. Additionally, the metal closeout cap can be bonded to the metal portion of the structural element. The process ends in step 78.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of manufacturing a reinforced hybrid structural element, comprising the steps of:
providing a metal element;
laying up a composite ply over at least a partial surface of the metal element; and
at least partially curing a polymer matrix using radiation in order to bond the composite ply to the metal element.

2. The method of claim 1, further comprising the step of placing an adhesive layer over at least the partial surface of the metal element, wherein the adhesive layer includes the polymer matrix and the step of laying up further includes laying up the composite ply over the adhesive layer.

3. The method of claim 2, further comprising the step of encapsulating the composite ply with the adhesive layer in order to form a corrosion-resistant barrier between the composite ply and the metal element.

4. The method of claim 2, wherein the step of placing further includes placing a plurality of glass fibers over at least the partial surface of the metal element.

5. The method of claim 1, wherein the step of curing further includes maintaining a temperature at an interface between the metal element and the polymer matrix within 75 degrees Celsius (approximately 135 degrees Fahrenheit) of a design application temperature.

6. The method of claim 1, wherein the step of curing further includes maintaining a temperature at an interface between the metal element and the polymer matrix below 120 degrees Celsius (approximately 248 degrees Fahrenheit).

7. The method of claim 1, wherein the step of curing further includes actively cooling the structural element.

8. The method of claim 1, further comprising the step of at least partially curing the composite ply using radiation.

9. The method of claim 1, wherein the step of curing further includes using an electron beam.

10. The method of claim 1, further comprising the step of removing a portion of the metal element in order to create a space for the composite ply.

11. The method of claim 1, wherein the step of laying up further includes locating the composite ply at a high-stress area of a structural element cross section under a loading type which the structural element is designed to carry.

12. The method of claim 1, wherein the step of laying up further includes:
laying up a resin and a plurality of reinforcing fibers, wherein the reinforcing fibers have a general fiber orientation; and
substantially aligning the fiber orientation in a direction of a loading which the structural element is designed to carry.

13. The method of claim 1, wherein the step of laying up further includes laying up a pre-cured composite ply.

14. The method of claim 1, further comprising the step of overlaying the composite ply with a metal closeout cap in order to protect the composite ply from a corrosive environment.

15. The method of claim 1, wherein the metal element includes at least one metal chosen from the following: aluminum, titanium and iron.

16. A method of fabricating a structural member of an aircraft, the method comprising steps of:
disposing a fiber reinforcement and uncured resin layer on the structural member, the structural member including an aluminum alloy; and
irradiating the resin with an electron beam to cure the resin.

17. The method according to claim 16, further comprising the step of:
disposing a carbon fiber reinforcement pre-impregnated with the uncured resin on in a channel milled into the structural member.

18. The method according to claim 17, further comprising the step of:
milling the channel into the structural member.

19. The method according to claim 17, further comprising the step of:
encapsulating the carbon fiber reinforcement in a fiberglass layer to substantially prevent the carbon fiber from reacting with the aluminum alloy.

20. The method according to claim 17, further comprising the step of:
disposing a layer of aluminum alloy to cover the carbon fiber reinforcement disposed in the channel.
